(19) United States
(12) Patent Application Publication
(10) Pub. No.: US 2015/0256423 A1
(43) Pub. Date: Sep. 10, 2015

(54) DATA COLLECTION, AGGREGATION, AND ANALYSIS FOR PARENTAL MONITORING

(71) Applicant: Charles Carey Stearns, San Jose, CA (US)

(72) Inventor: Charles Carey Stearns, San Jose, CA (US)

(21) Appl. No.: 14/643,402

(22) Filed: Mar. 10, 2015

Related U.S. Application Data
(60) Provisional application No. 61/967,050, filed on Mar. 10, 2014.

(51) Int. Cl. H04L 12/26; H04L 29/08

(52) U.S. Cl. CPC H04L 43/045; H04L 67/22

(57) ABSTRACT

In various example embodiments, a method and system to monitor activities on a plurality of devices associated with a common user are provided. The system includes an index component coupled to receive activity data from respective monitors installed on each of the plurality of devices, the activity data being associated with the common user and including an identifier associated with the common user. An analytics component is configured to aggregate the activity data using the identifier associated with the common user to generate analytics data relating to the activities on the plurality of devices associated with the common user, and also to present in the analytics data.

### RELATED APPLICATIONS

This application claims the priority benefit of U.S. Provisional Application No. 61/967,050 entitled “DATA COLLECTION, AGGREGATION, AND ANALYSIS FOR PARENTAL MONITORING,” filed Mar. 10, 2014 which is hereby incorporated herein by reference in its entirety.

### TECHNICAL FIELD

Embodiments of the present disclosure relate generally to data processing and, more particularly, but not by way of limitation, to data processing, including the collection aggregation and analysis of activity data for monitoring of activities on end-user devices.

### BRIEF DESCRIPTION OF THE DRAWINGS

Various ones of the appended drawings merely illustrate example embodiments of the present disclosure and cannot be considered as limiting its scope.

FIG. 1 is a block diagram of the parent-child monitoring base configuration, according to an example embodiment, using a monitored device, in this example an iOS mobile device. This figure shows example base system level architecture.

FIG. 2 is a block diagram, and supplements the block diagram in FIG. 1 by adding a second monitored device, according to a further example embodiment. The desktop machine illustrates certain benefits of remote data collection and device independent data aggregation.

FIG. 3 is a block diagram, further supplements the block diagram in FIG. 2 by adding an array of devices used by an end user (e.g., a minor or student), according to a further example embodiment. The system demonstrates the scale of example embodiment, and further benefits of multiple device data aggregation.

FIG. 4 is a block diagram, and further supplements the block diagram in FIG. 3 by including device data from other members in the immediate family, according to certain example embodiments.

FIG. 5 is a block diagram, and further supplements the block diagram in FIG. 4 by adding device data from other members in the community, according to certain example embodiments

FIG. 6 is a block diagram that describes the data flow and control between the monitored minor's compute device and the parent's viewport monitor, according to certain example embodiments.

FIG. 7 is a block diagram that builds on the flow diagram of FIG. 6 to describe the interaction between personal data and data from other family member, according to some example embodiments.

FIG. 8 is a block diagram for the illustrating an interaction between a computer system and a virtual private network server, according to some example embodiments.

FIGS. 9-11 are screenshots showing analytics data that may be outputted by an analytics server, according to some example embodiments.

FIG. 12 is a flowchart illustrating a process, according to some example embodiments, whereby usage events on an iOS mobile device are collected and sent to the index server based on preferences collected from the deployment server.

FIG. 13 is a flowchart illustrating a process, according to some example embodiments, whereby usage events on a VPN sever our collected and sent to the index server, based on preferences collected from the deployment server.

FIG. 14 is a flowchart illustrating a process, according to some example embodiments, to harvest text messages and send the messages to the index server, according to an example embodiment.

FIG. 15 is a screenshot illustrating personal data can be supplemented with community data, accordingly to an example embodiment.

FIG. 16 is a screen shot template of information displayed when the parent the clicks on the “What is this?” button in FIG. 15, according to example embodiment.

FIG. 17 is block diagram showing a high-level client-server-based network architecture, according to some example embodiments.

FIG. 18 is a block diagram illustrating an example of a software architecture that may be installed on a machine, according to some example embodiments.

FIG. 19 illustrates a diagrammatic representation of a machine in the form of a computer system within which a set of instructions may be executed for causing the machine to perform any one or more of the methodologies discussed herein, according to an example embodiment.

The headings provided herein are merely for convenience and do not necessarily affect the scope or meaning of the terms used.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Increasingly, schools are requiring that mobile devices (e.g., mobile phones, tablets and laptops) be used in school, either to supplement existing learning materials or replace them altogether. In either case, the child's use of the mobile device is a concern to parents who recognize that unfettered access to digital media and online material can be harmful. Traditionally, parental control software has played the role of protecting children by blocking access to web sites. Parental control software is installed on the minor's computer to block websites and selected applications by means of filters created by parents. Creating usage rules and internet browser filters that keep children from thousands of adult sites has always been a difficult task, if not impossible. But made even more difficult by the proliferation of smart phones and tablets that do not allow 3rd party controls to monitor or block online content. Sometimes referred to as “sand boxing”, a 3rd party Apple iOS application is not allowed to monitor browsing activity, video file usage, audio file usage, text messages, game usage, or program installations. These are all activities that parents would like to monitor in order to govern and instruct their child's use of the mobile device.

Parental control software may be installed on the minor's computer and provides a user interface for parents to restrict browsing web sites and application usage. The parental control process requires that a parent know and review a list of web sites likely to be visited by the minor. Inappropriate sites are identified and black-listed. Black-listing a site means the parent does not want the minor to see the site and the browser is prevented from visiting the site. Because there are billions of sites, this task can be formidable. Instead some parents opt to black-list all sites and create a smaller white-list of sites the minor is allowed to visit. The same black-list/white-list process can be applied to application usage. For example, a parent may black-list a popular game from being executed on a computer. Or white-list Microsoft Office for application tools school use. White-listing requires constant and immediate updating of data to avoid inadvertent blocking useful sites and preventing a minor from being productive.

Companies that provide browsers for surfing the Internet typically do not provide a means for third party parental control software to monitor or restrict web site browsing. To get around this, some parental control software providers block the running of all commercially available browsers, and instead supply their own browser for surfing the Internet. The parent-control-enabled-browser is responsive to parental control white-lists and black lists. Unfortunately, the adoption and pre-installation of 3rd party browsers is statistically low as compared to the better marketed and distributed browsers: Microsoft's Internet Explorer, Apple's Safari, and Google's Chrome. As a result, the number of minors using parental control enabled web browser is near zero.

Parental control software may also attempt to collect web browsing activity and other computer activity from the minor's computer and send the activity data to a cloud server for parental viewing. The collected activity from only one of the minor's computer is limited due to restrictions inherent in the device′ operating system and the pre-installed web browser mentioned above. All of which do not support 3rd party parental controls; including a means for a parent to restrict access to select sites and applications. Hence the data collected on the cloud server is sparse and uninformative.

For years, corporations have been developing technology that monitors employee activity on corporate networks. This security software runs either on the network router or on the company server.

In certain circumstances, routers may provide advantages over parental control software because all computer browsing activity needs to pass through the router to reach their destination. Unaffected by browser limitations (mentioned above), an intelligent router sits between the browser and the Internet and can both log network traffic and block network access. Routers have the ability to effectively implement a white-list/black-list system similar to parental controls objectives mentioned above. One limitation of the router is that its capabilities can only be used if the computer sits behind the router on the corporate network. If the computer is a laptop or mobile device, and the device is off the company network then the router is not able to monitor the data traffic. For example, if the device is a laptop in a coffee shop, out of reach of the company network, then the network traffic flows through the coffee shop's Wi-Fi router to the public Internet.

To address offsite network access requirements, corporations may use virtual private networks (VPN) to extend their networks to employees working off site. The VPN provides a secure (encrypted) connection between the employee's computer and the company's router, even in a coffee shop. The remote computer first authenticates itself across the insecure public network, and then sends encrypted network requests to the VPN server. Network requests to surf the internet are typically not routed across the VPN, through the company server to the Internet. Rather an Internet request will flow unmonitored and unrestricted across the non-VPN network onto the coffee shop's network. Hence, the ability to monitor and or control a person's on-line activity when surfing the Internet on a public network may be elusive.

A new class of VPN service providers seeks to provide an individual the ability to subscribe to a VPN service for personal use. The service routes all public Internet access through their servers, but the service is marketed as a means to “hide your IP address”. And as such, VPN service providers do not provide any means to monitor or restrict a person's Internet traffic through their VPN servers.

In the final analysis, parental control software, smart routers, and VPN networks do not provide a means for a parent to view or restrict the activity on a minor's computer. Parents want information not currently available from these solutions today. Parents are interested in a child's online browsing activity across a variety of locations: in the home, at school, and in the coffee shop. Beyond web browsing, parents would like to know what applications are being used, where their child is, what video is being watched, what songs are being listened to etc. Visibility into text messaging solicitation, bullying, and sexting may be of particular interest to parents.

The example embodiments described herein seek to provide tools to address the existing limitations and gain insight not addressed by current solutions. The example embodiments described herein include a system that allows parents to monitor a child's use of a computer, including sand-boxed mobile devices. The example system collects data from a multitude of platforms and correlates the data on a remote server for remote viewing by the parent. The monitored data from multiple computer devices is collected on the cloud server and held in a repository, which may be accessible only by the parent. Analytics on the server uses the information from a large quantity of machine data associated with the child and the child's use of the computer. The raw, aggregated computer usage data may be unwieldy and therefore analytics helps to manipulate, summarize, and visually present meaningful results to the parent. The visual results help the parent to see details and trends towards better understanding the child's computer activity.

In addition, certain example embodiments include a remote control capability that alters the amount and type of data that gets collected and reported. The remote control specification is collected in a “preference file” that is periodically sent to each computer device used by the child. The resident preference file instructs (or configures) the installed computer monitor application what to collect, how often to collect, and where to send the data.

In some embodiments, having data stored on a cloud server, opens the door for community assistance. With parental authorization, results can be shared with other people who are helping to raise the child. Results can also be shared with a broader community of trusted individuals who would benefit from sharing observations and past similar situations.

A method and system to monitor activity on multiple devices associated with a common user are described.

Activity data is received by a central server (e.g., an index sever) from respective monitors (e.g., monitoring applications or “collectors”) installed on, or coupled to, each of the multiple devices. Activity data is thereafter associated with the common user. To this end, the activity data may include (or be tagged with) identifier(s) associated with the common user. At an analytics server, the activity data is aggregated and analyzed using the identifier(s) associated with the common user to generate analytics data relating to the activity on the multiple devices associated with the common user. This analytics data is then presented by the analytics server.

An identifier with which the activity data is tagged may include a device identifier, and the aggregating of the activity data may include determining that the device identifier is associated with the common user. In another embodiment, the identifier may be user identifier, and the aggregating of the activity data may include aggregating activity data that includes the user identifier.

The integrity of a monitor of a first device of the multiple devices may be validated by another monitor of the first device (or another device).

In one embodiment, first activity data from a first monitor and second activity data from a second monitor may be received at the index sever, the first and second monitors being installed on a common device. The first activity data may pertain to a first type of activity and the second activity data pertains to a second type of activity. For example, the first monitor may sample and collect browser URL data from a browser installed on the first machine, while the second monitor may sample and send application usage data for a different application (e.g., a game application) also installed on the first machine. Accordingly, the first activity data may pertain to activity of a first application installed on the common device, and the second activity data may pertain to activity of a second application installed on the common device.

The activity data may also include at least one of location data, network traffic data, browser URL data and media data (e.g., a photo or video) associated with an activity performed using a first application installed on a first device of the multiple devices. To this end, a monitor may have the capabilities to take a screenshot or video of activity at a particular time relating to a particular application, and include this image data within the activity data that is provided to the index component (e.g., index server).

The aggregating of the activity data may include determining that a first monitor on a first device of the multiple devices experienced a termination event (e.g., by determining that the first monitor failed to generate first activity data correlated second activity data generated by a second monitor on the first device). For example, it may be assumed that a monitor associated with a particular application installed on a mobile or tablet device (e.g., a monitor associated with a browser) has been terminated, if another monitor associated with a proxy server application on the mobile device is reporting URL events. Likewise, on a desktop computer, if a first monitor is reporting recent browser activity, but a monitor associated with a proxy is not sending URL data, it may be assumed that the monitor associated with the proxy has been terminated (or even uninstalled).

In yet a further example embodiment, analysis of activity data (e.g., of device sleep event data) on a central server (e.g., an analytics server) may be performed to determine whether a monitor has been terminated. Consider a situation in which a first monitor (e.g., monitoring application running in a background mode) may detect that a host device has gone into sleep mode by receiving a report of a device sleep event. A second monitor, on the same device and also running in the background, may separately sent network activity information to the central server. Accordingly, if the host device goes to sleep, the first monitor application reports this event. If either one of the monitors is terminated by a user of the device, the other monitor is nonetheless able to report to the event. On the hand, if a device is powered off, then both monitors simultaneously stop sending activity data.

Turning specifically to a monitor installed as part of a computing device (e.g., a monitoring application installed on an iPad tablet), a monitor may run in the background and sample both process data and location data. Process data (or monitored processes) may be filtered by periodically retrieving a filter file maintained on a remote, centralized server (e.g., a deployment server described below). Similarly, application controls (e.g., the preferences discussed below) may be centrally stored, polled and retrieved at regular intervals.

In one example embodiment, activity data sent by a monitor to a central data repository (e.g., an index component or server) is uniquely tagged with a device tag (e.g., indicating the device from which it originated), a user tag (e.g., identifying a student user associated with the device), and a parent tag (e.g., identifying a parent of the student user). Accordingly, results can be aggregated across devices for a particular parent, but also individually recognized and analyzed.

In a further example embodiments, a proxy or VPN application may be installed on a device that services URL requests for a particular client (e.g., an iPad), but additionally samples HTTP traffic for domain and URL tags. These tags are correlated with a unique user identifier, and sent to a remote server (e.g., the index server) for combination with the connected user activity data.

In order to provide meaningful analytics output, and analytics server (described in further detail below), may support an application and URL categorization scheme, which assigns applications and URLs to categories that are specific to a particular user (e.g., student or parent). Application categories for this categorization scheme may be seeded from application categorizations from publicly available application stores (e.g., the Android app store or the Apple App store). Similarly, URL categories for this categorization scheme may be seeded from a web filter systems. One example embodiment further provides a mechanism for users (e.g., a parent or an administrator) to further investigate URLs and applications, compare findings with other users, and update and share a categorization scheme database.

A central server (e.g., a deployment server) may send control information (e.g., parental preferences 217) to monitors installed on client devices in order to change certain operating conditions of a monitor to accommodate parental requirements. This control information may specify, for example:
What data the monitor should sample (e.g., by specifying a particular application, as well as data specific to that application);
Frequency with which the data should be sampled (e.g., every 20 seconds); and/or
Whether a GPS component of the client device should be used to sample location data.

As will be described in further detail below, a central server (e.g., a deployment server) may present an interface (e.g., an API), which allows a parental user to log into the central server, and customize behavior of each monitor (e.g., monitor application) installed on multiple devices that the parental user may wish to monitor. Each monitor then polls the remote server (e.g., deployment server) for updates, and is accordingly able to determine when new updates have been specified.

A further example embodiments may facilitate the monitoring of Wi-Fi and wide area network (WAN) packets to determine whether controls of a particular entity (e.g., parental controls instituted by a school) are being bypassed. This may be important, for example, to educational institutions which implement policies requiring that students must use a campus Wi-Fi while on school premises. Such policies seek to force students behind a “web filter” operated by the school. In one embodiment, a monitor on mobile end-user devices may sample packets arriving at, and departing from, various sockets or interfaces of a mobile device (e.g., both WLAN and WWAN sockets) to assess whether policies are being complied with. Additionally, statistical results may be generated either on a client device, or at a centralized server, for viewing by an entity administrator or a parent.

Activity data across devices associated with a group of users (e.g., a student body at an educational institution or within a specific geo-fence, such as a campus) may, in certain example embodiments, also be facilitated. In this example embodiment, central servers (e.g., an index, analytics or deployment server) may be configured to keep each user's collected activity data separate and distinct (e.g., within a dedicated use the “sandbox”) on a server. However, an additional mechanism exists to aggregate this activity data by removing personally identifiable information (PII), and then to group this activity data (e.g., by entity or school, and report the resultant data to an administrator (e.g., a school administrator).

In some example embodiments, a mechanism is provided to collect chat messages (e.g., iMessages) by creating a “side account” on a MAC server hosting a monitor to parse an underlying file (e.g., iMessages sqlite.db file). Here, a monitor is able to intercept SMS/text messages sent using Apple's iMessage application, and then send these messages to a central server (e.g., an analytics server) for analysis.

Some embodiments may also support an authorization scheme, which requires a supervising user (e.g., a parental user) to first register on a centralized server before enabling any number of remote monitors. Any number of monitors can be downloaded from an online source (e.g., an app store), and used for a trial period of time. Registration and payment on a central server sends “tokens” to each monitor to extend functionality and life of the relevant monitor.

Some embodiments may also facilitate to the user (e.g., parental or administrative user) creation of behavioral rules which drive data analysis, and trigger alerts back to the user. For example, a parental user may browse to an online centralized server and use an online menu to build a rule (e.g., no more than three hours of games and social media on weekends). The created rule forms the basis for ongoing, future custom analysis that results in a dashboard alerts, or email alert, if the rule is transgressed.

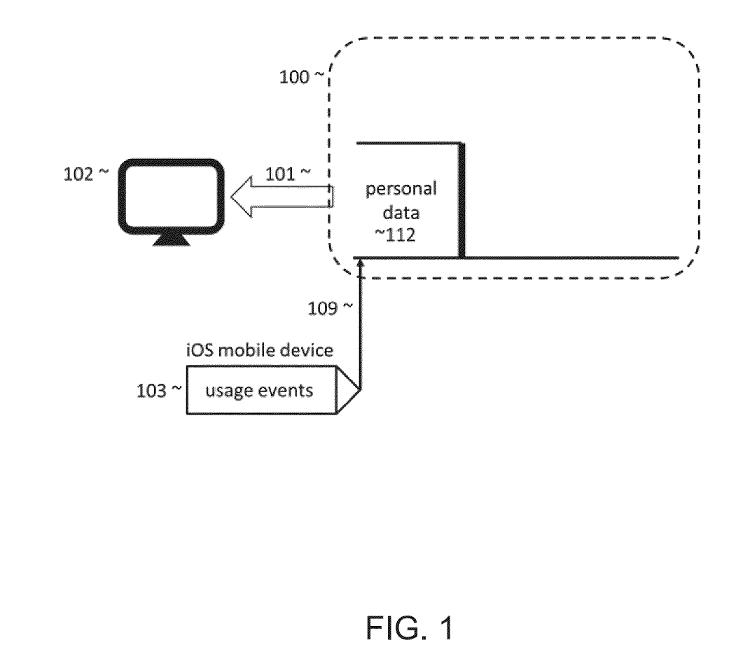

An example scheme of data collection, remote viewing, remote control of data collection, and community sharing, according to an example embodiment of the present invention, is described below. FIG. 1 is a block diagram illustrating a flow of data, according to an example embodiment, between a child's activity on a single mobile device (e.g., an iOS mobile device) and the monitor used by the parent to see resultant usage data analysis.

In FIG. 1, the child's electronic mobile device (e.g., a mobile device (103)) is both collecting and sending activity data, in the example form of usage data (109), to a remote server (100) that in turn provides the visual graphics analysis (101) to a display (102) for parental viewing. The usage data (109) may include a device identifier for the mobile device, or may alternatively include a user identifier identifying the user (e.g., child) of the mobile device. In a yet further embodiment, the usage data 109) may also be tagged to include a parent identifier, identifying a parent of the user. The identification data included within the usage data (109) may be included in a message packet transmitted from the mobile device to the remote server (100).

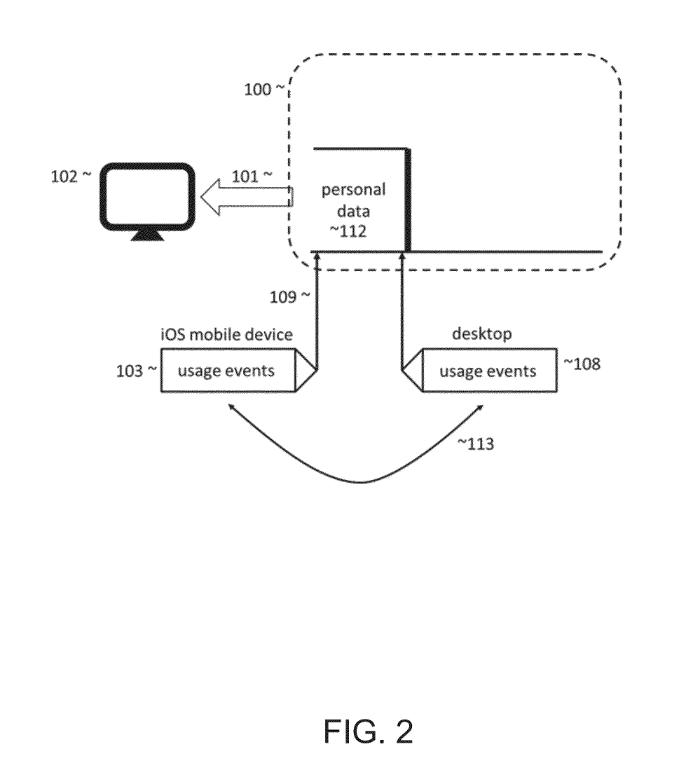

When a child is using a mobile device (103), a limited amount of usage data may be allowed to be collected. This may be per the operating system developer specifications and their intended design. The operating system developer may not allow an iOS application to collect data beyond location, CPU utilization, power, and the current active processes. Missing, for example, are web browser information, text messages, video and audio file viewing, and application installation information, all important activities that parents want to know and understand. The usage events from the mobile device (103) are therefore limited, but contributory and different from data available from the minor's desktop computer (108 in FIG. 2).

In FIG. 2, when a child is using a desktop computer (108), the computer usage data typically includes video, audio consumption and application installs. In and of itself, this is limited data. But the data type is different from iOS data types and a valuable contribution to the whole.

If the desktop computer (108) is used as a docking station for the mobile device (103), then the desktop computer (108) can further collect and report web browsing data and text messages from backup data found on the desktop computer (114). This is another unique set of data contributing to the whole (112) that originated from the mobile device (103).

FIG. 2 illustrates the mobile device (103) and the desktop computer (108) providing data to the server (100). The server (100) extracts a subset of information from the mobile devices and a subset of information from the desktop computer (108). The data from the desktop computer (108) includes desktop activity data and mobile backup data (113). The analysis of the data is now made up of the combination of the mobile data (109), the desktop data (108), and the mobile data backed up on the desktop computer (113).

In example embodiments, one example innovative feature is the remote association and identification of a variety of computer and intra-computer events that can be correlated with a specific user and combined to present a unified view of a child's activity over time.

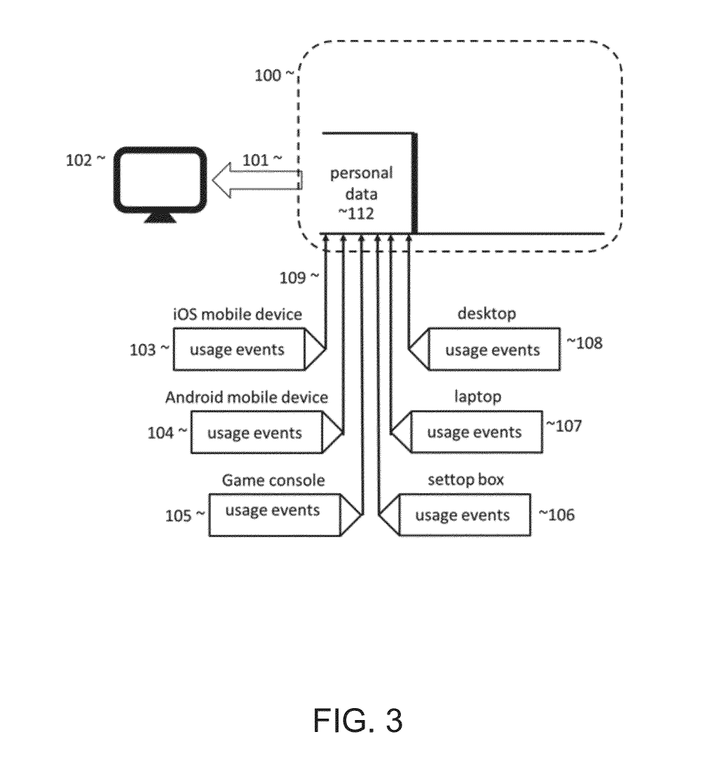

Activity data, in the exemplary form of collected usage events from a minor's mobile device (103) and desktop computer (108), are sent to a server (100) begins to build a repository of information (112) associated with the child behavior. As shown in FIG. 3, the personal data repository (112) can be further supplemented with data usage events from other operating system (e.g., Android, Windows Phone, Blackberry etc.) mobile devices (104), laptop computers (107), game consoles (105), and set top box (106). Each device taken on its own does not provide a full account of the child's activity. For example, laptops typically do not provide location information, whereas an Android device does. Not all devices need to be in use by the minor at all locations and time, because data is shared between devices and any valuable data on one device could be more readily accessible on another device. The combination of usage data from more devices and machine data shared between devices helps the parent understand what the child is doing.

On demand, the parent (102) can log on to the server (100) and access the child's personal data. The data repository (112), over time, will become a large volume of text machine data and may be difficult to read, parse and understand. In one example embodiment, the remote server indexes and analyzes the data on behalf of the parent. Correlated results of the raw data depend on the variety and scope of collected data, but can be informative as:
What application was the child using at a specific time?
What application was the child using at a specific location and time?
What browsing activity spawned an application at a specific location and time, and what did the application do?
What application was used to receive a compressed video file, what was the video, and was that video watched?
What messages were sent to which friends at what time using what application or website?

Further rolling up the data and using analytics to create trend data can be as informative as:
What percentage of the child's activity is being spent on homework, and is that trend increasing or decreasing?
How the student's grades are affected by that trend and what is the predictive analysis of future grades?
How does the sentiment of text messages compare across groups of message recipients?
Is there a person or group that is exhibiting hostile behavior as compared to other groups?

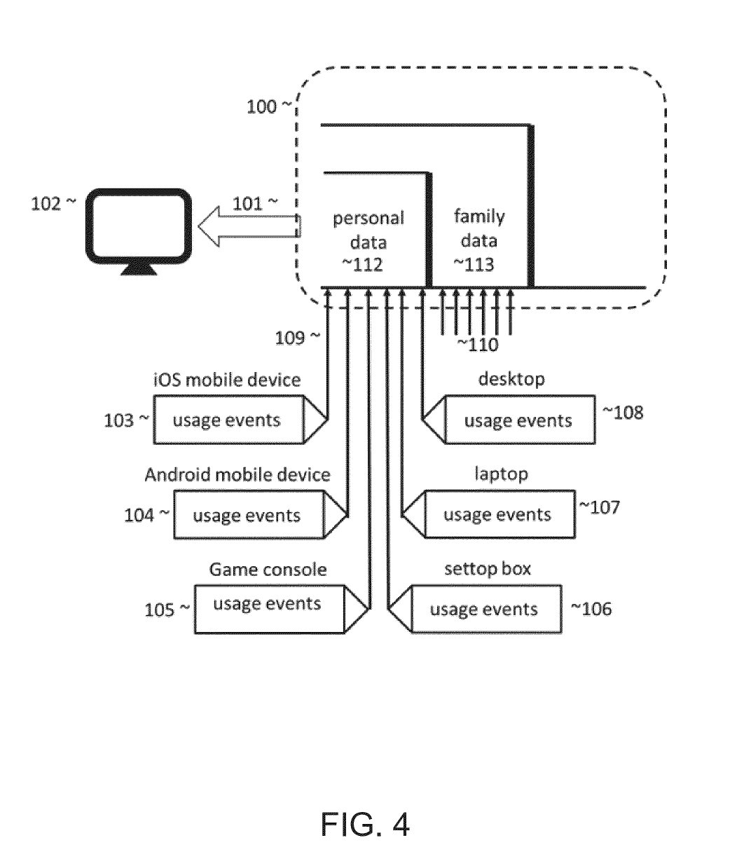

As alluded to in the last set of analysis examples, further analysis may be enhanced by including collected data from the child's context. As shown in FIG. 4, the most immediate context is data from other family members.

As shown in FIG. 4, data collected from other members of the family (110) from devices that they use, is stored in a distinct and separate server repository (113). The repository (113) is a collection of individual repositories, but whose data may be devoid of person identification. The data (113) is useful for providing a context to the personal data found in the personal repository (112).

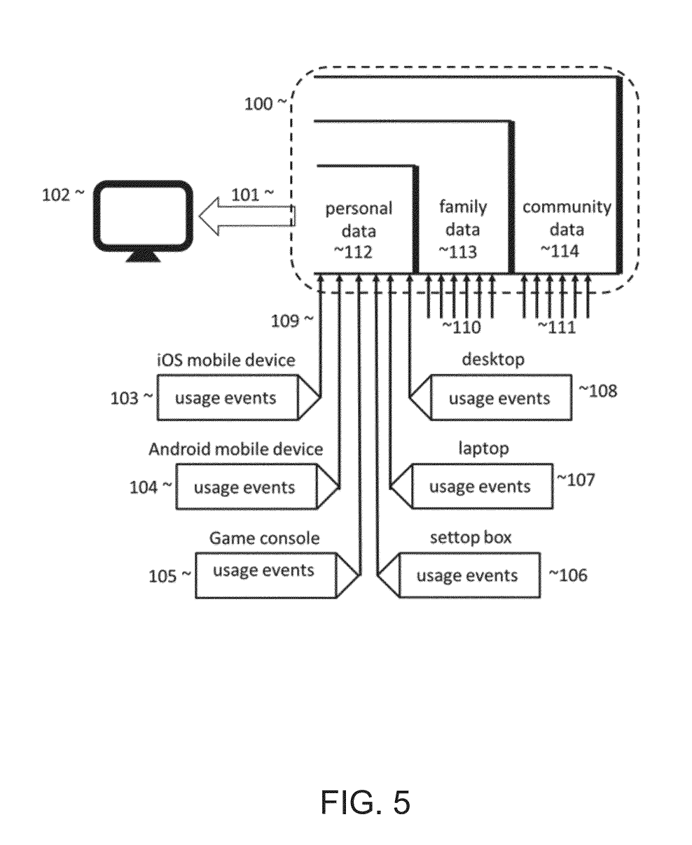

In addition, as shown in FIG. 5, the inclusion of community data (114) in the analysis process may help to further hone analytic results. The incoming stream of community data (111) is similar to family data (110) in that it is an anonymous refinement of device usage data collected from the same types of personal devices (103, 104, 105, 106, 107, and 108) used by individuals in the community. In some example embodiments, the community may have students attending the same school using mobile similar mobile devices, desktop computers, and game consoles. The data collection from each student provides an environmental context of the individual student and to which the student is being exposed.

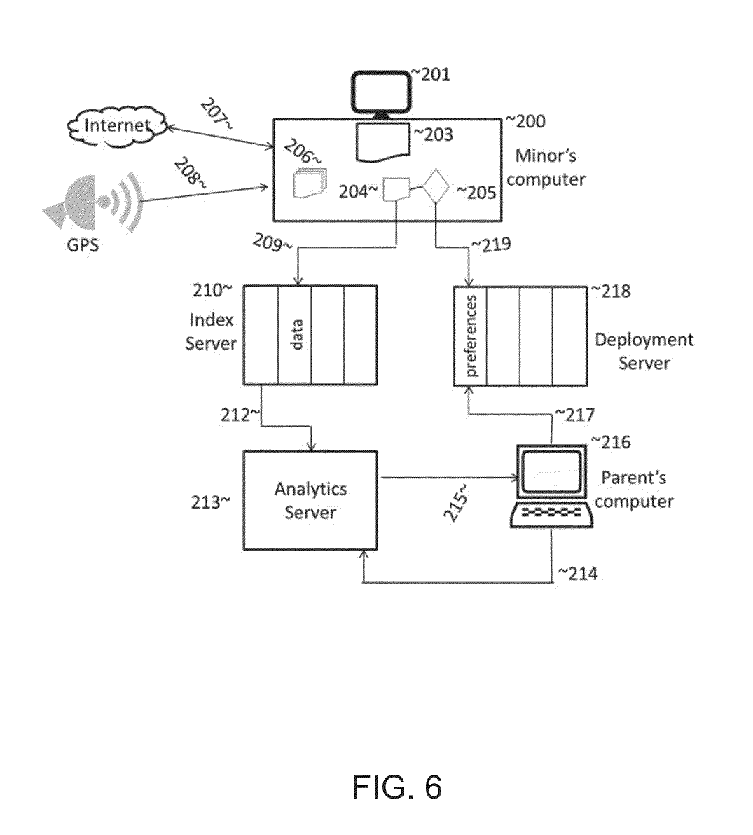

FIG. 6 illustrates further implementation details, according to some example embodiments, relating to the mechanisms and processes of data collection, analysis, and control.

A parent starts the process by installing a monitor, in the example form of a monitoring application (204), on the minor's computer (200). In other embodiments, the monitor may be a hardware device or accessory that is coupled to the minor's computer. This hardware device may include both hardware and its own software.

The monitoring application (204) may run in the background with other background applications (206) and is different from the forward application (203). The forward application (203) may drive the minor's display (201) and is the focus of the minor's attention. On every computer and/or mobile device there are a number of running background applications or processes (206). Background processes (206) may be file system daemons that maintain the proper functioning of the computer device, but do not require user interaction or the display monitor (201). Examples of background applications are processes that maintain the network connection (207) and the process that samples the incoming GPS data (208).

Similar to background processes (206) mentioned above, the installed monitoring application (204) runs in the background and has access to a limited number of resources, some of which may be of interest to the monitoring parent. For example, in mobile devices, the GPS data is available to background processes, as well as which processes are running both in foreground (203) and background (206).

The information available to the monitoring application (204) is sampled periodically to generate activity data in the form of activity samples (209). The resultant samples (209) are sent to the index server (210). As mentioned above, these samples (209) may be tagged with various identifiers, including a device identifier, user identifier and parental (or supervisor) identifier. The index server (210) is responsive to incoming streams of monitor samples and stores the sampled data locally in index server (210) storage. The source of the data is carefully associated with each sample, so that data repositories are not mixed and privacy is preserved. To this end, an identifier with which the sample is tagged may be used to associate the sample data with its source.

Separately, the parent operating the parent's computer (216) can request data analysis from the analytics server (213). The analytics server (213) responds to the parent's request by reading large amounts of indexed data (212) and performing the requested analysis.

Data analysis on the minor's data may be enhanced by inputs and insight from the parent (214). For example, the parent can help guide the analysis by indicating which set of URL events are associated with school. Tagging URLs and applications samples with a predefined set of categories helps the analysis server parse and summarize the otherwise large volume of data collected on the index sever (210).

After viewing the minor's analyzed data, the parent can adjust the amount and type of data being collected by the monitor application (204). The parent can, for example, adjust the frequency of sampling and what type samples to collect at what times. Specifically, the parent may elect to sample location data (208) every 5 minutes at a geo-resolution of 100 meters.

These parental preferences (217) are sent to a deployment server (218) and held in memory until the monitoring application (204) on the minor's computer (200) polls the deployment server (218) for new preferences. On polling, the minor's computer (200) pulls down the preference file and stores the preference file (205) on the minor's computer (200). Thereafter, the monitoring software (204) adjusts its behavior according to the data in the parent's preference file (205).

In some example embodiments, the monitoring software (204) both sends monitoring data (209) to an index server and separately polls (219) a deployment server (218) for behavior adjustments. Data is not pulled off of the minor's computer (200) by the indexer server (213) and data is not push down to the minor's computer (200) by the deployment server (213).

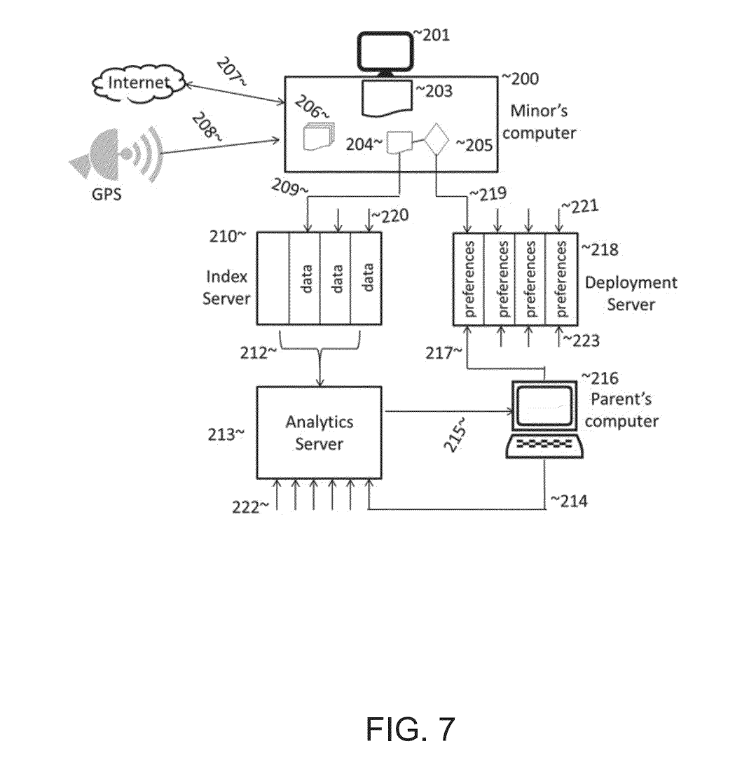

The monitoring and data analysis is further enhanced by including family and community data. Referring to FIG. 7, the index server (210) is not only a repository for a minor's personal data (209), but additional monitor samples from other family members and fellow students (220). The larger set of collected data from the minor, the family, and the community (212) is sent to the analysis server (213).

Again, leveraging the collective insights of fellow parents in the same community, the analysis server (213) collects tagging, categorization data, white list, and black list data from other parents (222) to help refine and analyze the minor's activity data.

Treated differently, parental preferences from other parents (223) may likewise be stored on the deployment server (218), but not combined in any fashion. Each individual parent has the ability to remotely control their minor's computer without any influence from another parent's preferences on the same server (218).

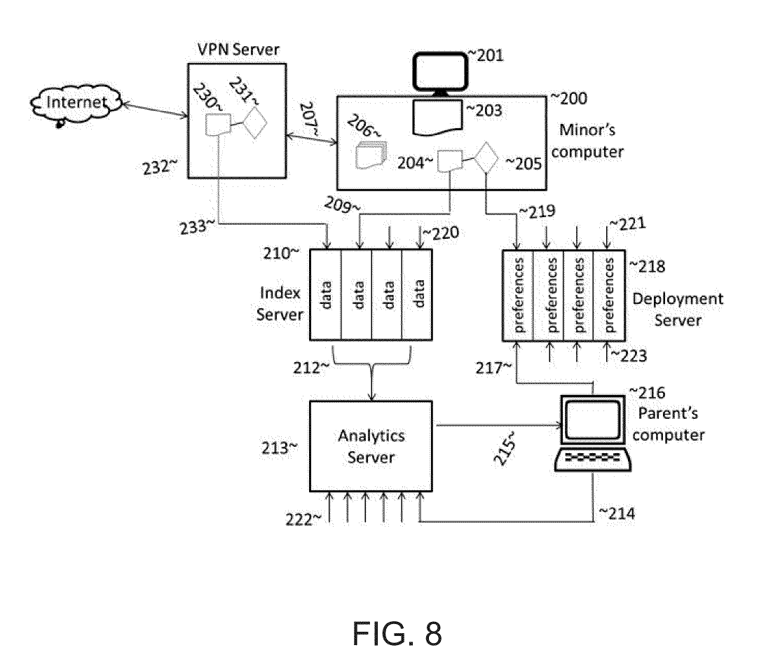

An additional source of data from the minor's use of a network connected device is shown in FIG. 8. In FIG. 8, the minor's computer (200) is configured to send HTTP requests to a virtual private network “VPN” server (232). The Internet traffic through the VPN server (232) is sampled using an installed monitoring application (230) similar to the monitoring application on the minor's computer (204), but tailored to the specific needs of capturing network packet traffic specific to the minor according to the associated preference file (231) distributed from the deployment server (218). The data (233) harvested from the VPN monitoring application is sent to the index server (210) for inclusion in the parental analysis.

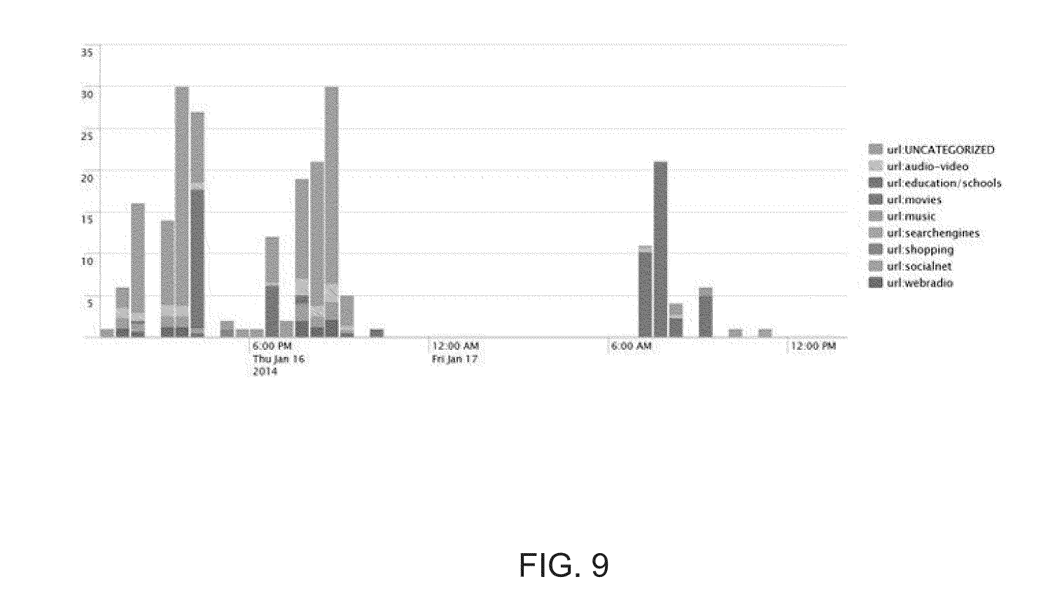

The screenshot in FIG. 9 is an example of the collected data graphically displayed on the parent's computer (102). In this example, the browsing data (233) harvested from the installed monitoring application (230) in FIG. 8 is categorized on the analytics server (213) and displayed graphically on the parent's computer (216).

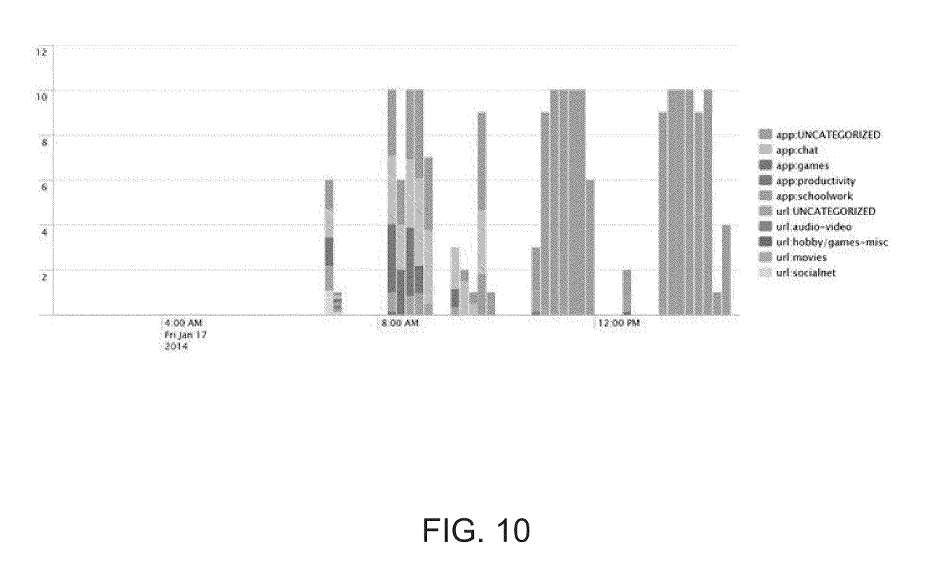

The screenshot in FIG. 10 is an example of the collected data graphically displayed on a parent's computer (102) that includes data from two different sources. In FIG. 10, the data is harvested from the VPN server (232), and the app data is harvested from a desktop computer (108). The data is combined on the index server (210), categorized on the analytics server (213), and graphically displayed on the parents' computers (216).

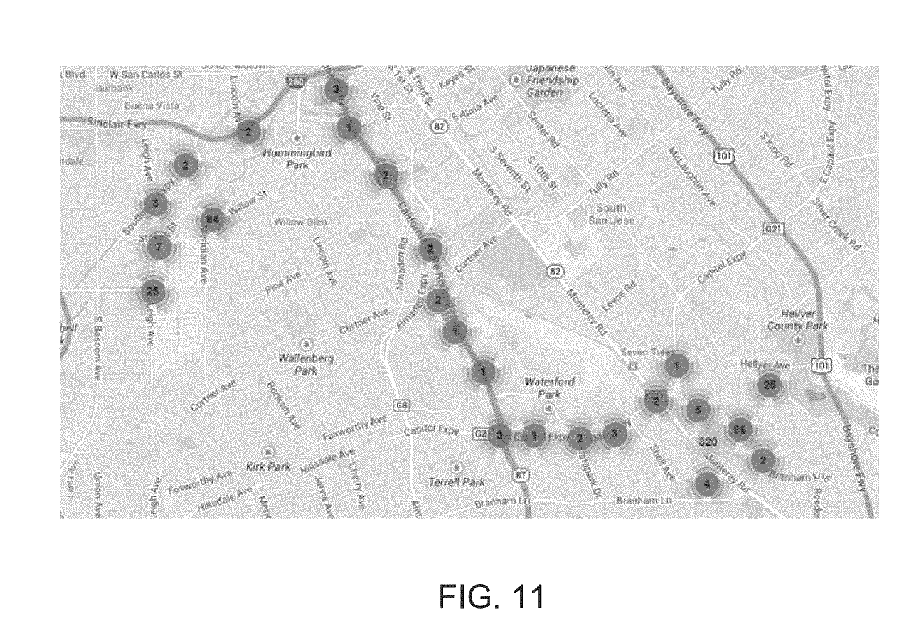

The screenshot in FIG. 11 is an example of the collected data graphically displayed on a parent's computer (102) that includes data from three different sources. The markers on the map indicate location. Each number on each map marker is the sum of the browsing events and application events that occurred at the location. In this example, the location data is harvested from the iOS mobile device (103), the browsing data is harvested from the VPN server (232), and the app data is harvested from a desktop computer (108). All three event sources are forwarded to the index server (210), categorized on the analytics server (213), and graphically displayed on the parents' computers (216).

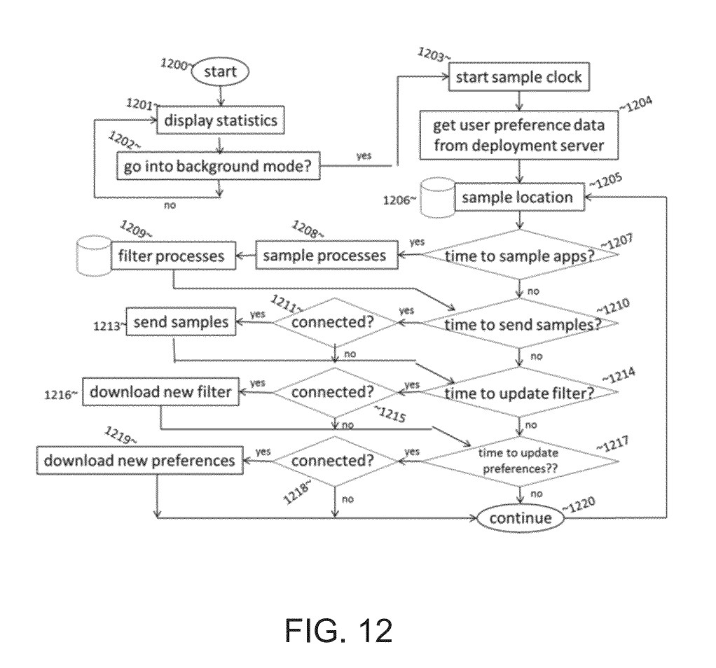

FIG. 12 is a flowchart illustrating a process, according to some example embodiments, whereby usage events on an iOS mobile device (103) may be collected and sent to the index server (210) based on preferences collected from the deployment server (218). The execution flowchart of FIG. 12 maybe executed by a software application running on the iOS mobile device. The application starts in the foreground (1200) and displays information about the iOS device and the amount of data collected. The application switches to a background application (1202) when the user of the mobile device switches applications. In background mode, the application starts a clock (1203) with a predetermined period (e.g., 20 seconds). After starting the sample clock, the application uses the iOS mobile device's network to contact the deployment server and receive preference data (1204) specific to the operation of the mobile device. Preference data may specify:
How often to sample processes.
What data to preserve.
What data to delete.
The accuracy of the location samples.

After receiving and applying the preference data, the application samples the mobile device current location (1205). Location data can be determined using the mobile device GPS, cellphone triangulation, and/or Wifi coordination. The sampled location data is stored in memory on the mobile device. Based on the number of sample clock periods, a user's preference may elect to also sample processes running on the mobile device (1205).

At the elected time, the application collects the names of all processes running on the mobile device (1208). The list of sampled processes is compared against a list of processes that should not be reported (1209) and the surviving process samples are stored in the mobile device memory.

The application then looks at the number of sample clocks and user preference data to determine if it is time to send the stored samples to the index server (1210). If it is time to send samples, network accessibility is first checked (1211) before sending both the location samples and the process samples to the index server (1213).

The application then counts the number of sample clock periods and user preferences to decide if the process filter needs to be updated. The process filter is used (1209) to determine if certain process samples are uninteresting and should be filtered out.

In operation (1216) a new list of processes by name are downloaded from the deployment server, based on the availability of the mobile device network (1215). Before incrementing the sample clock and sampling the location data again (1205), the application checks to see if the preference data is stale (1217), if the network is available (1218) and then proceeds to download new user preferences from the deployment server (1219).

The loop from “Sample Location” (1205) to Continue (1220) runs indefinitely, sampling data and sending data to the index server until the user pulls the application out of background mode and into the foreground. At which point, the application stops sampling and sending and sits idly displaying the statistics (1201).

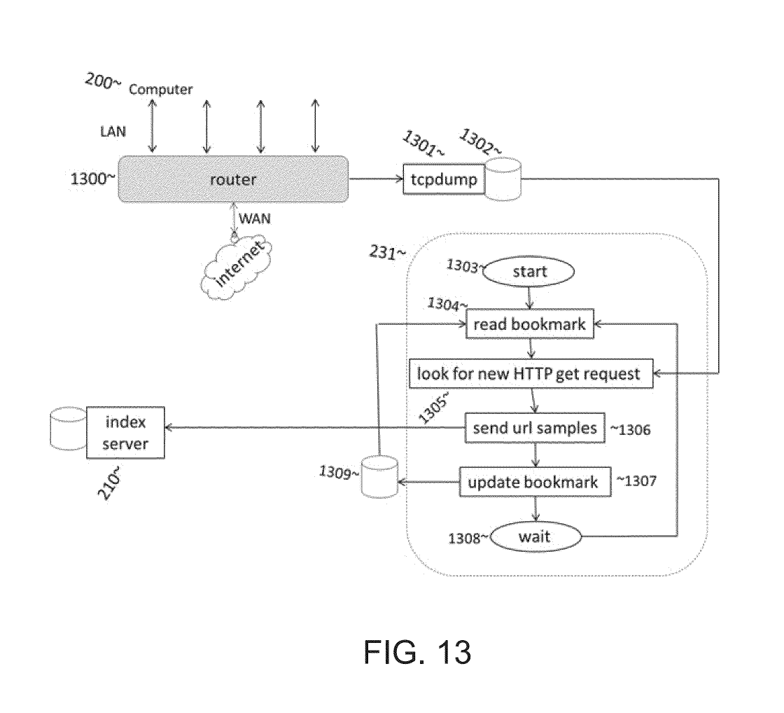

FIG. 13 is a flowchart illustrating a process, according to some example embodiments, whereby usage events on a VPN sever (232) may be collected and sent to the index server (210), based on preferences collected from the deployment server (218). The execution of the flowchart shown in FIG. 13 maybe executed by a software application (231) running on the VPN server (232). As is normative with a VPN server, computers (200) on a LAN get access to the Internet through a router. In this configuration, the additional presence of a software program (1301) runs on the VPN server and collects HTTP GET requests in a database (1302) stored on the VPN server. Examples of well know and available programs that collect network traffic (1301) are tcpdump, Bro, and Snort.

The additional application that runs in parallel with the network sniffer on a separate thread is the installed monitoring application (230). The monitoring application starts (1303) and reads a file (1309) with a timestamp of the last time HTTP GET request collected and sent to the index sever. The timestamp is referred to as a “bookmark” (1304). The bookmark is used in operation (1305) to find all HTTP GET requests in the network sniffer database. Only the new events from the database are collected and passed on to operation (1306). The new HTTP GET request records parse from the database may contain the senders IP address and the target URL. The collected data is sent to the index server (210) before updating the bookmark (1307). The timestamp of the latest HTTP GET request is used to update the bookmark (1307). Afterwards, the application may exit or sleep for a few seconds before returning to operation (1304) to repeat the process.

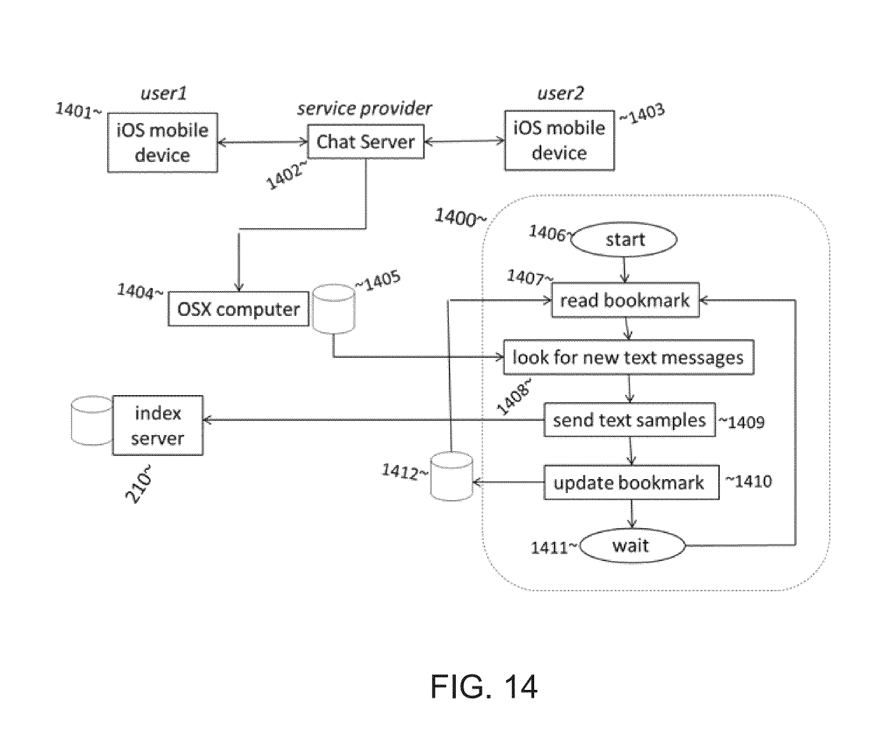

It will be appreciated that there can be other computers and servers in the network that manage personal data. That data can be sampled and sent to the index server. Another such device is, for example, the chat server. As shown in FIG. 14, a chat server (1402) may be a machine that manages the text message communications between two mobile devices, for example two iOS mobile devices (1401 and 1403) in FIG. 14.

The chat server is programmed to not only pass messages between sender and recipient, but copy messages to authorized computers. In FIG. 14, the authorized machine receiving both sender and receiver messages is an OSX computer (1404), which stores the text messages and associated timestamps in its local memory (1405).

The flowchart shown in FIG. 14 illustrates how an application (1400) running on the OSX computer (1404) manages to harvest text messages and send messages to the index server (210).

The monitoring application starts (1406) and reads a file (1412) with a timestamp of the last time text message collected and sent to the index sever. The timestamp is referred to as a “bookmark” (1407). The bookmark is used in operation (1407) to find text messages in the OSX database (1405). Only the new events from the database are collected and passed on to operation (1409). The new text messages parsed from the database typically contain the sender's unique identifiable names and the message. The collected data is sent to the index server (210) before updating the bookmark (1410). The timestamp of the latest text message is used to update the bookmark (1412). Afterwards, the application may exit or sleep for a few seconds before returning to operation (1406) to repeat the process.

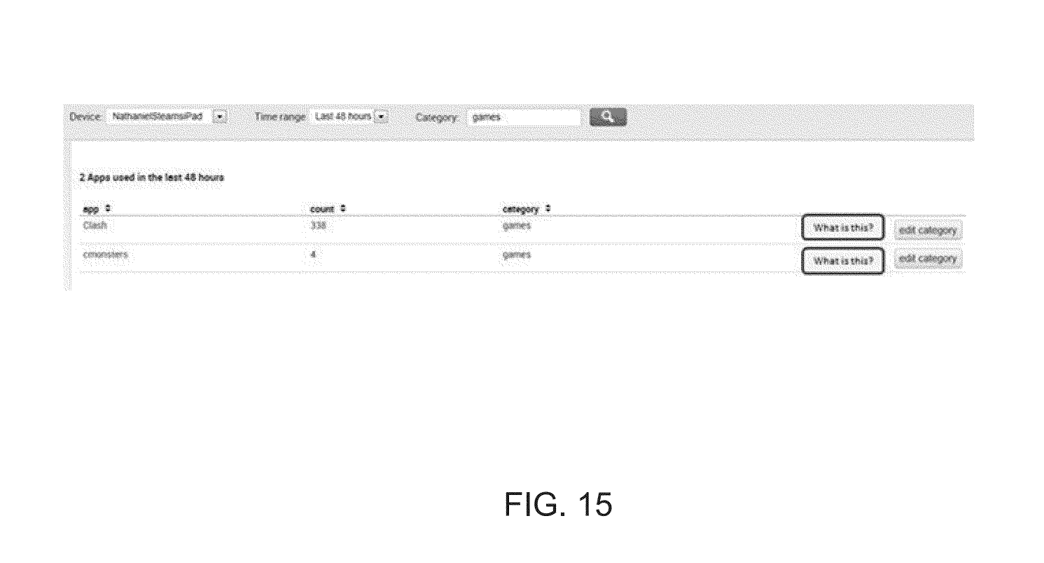

The screen shot shown in FIG. 15 illustrates how personal data (112) can be supplemented with community data (114). In this example, personal data indicates that the child has played two games over the last 48 hours: Clash and cmonsters. If the parent is unfamiliar with these games and would like to get more information about these games from the parent community, then the “What is this?” button can be clicked.

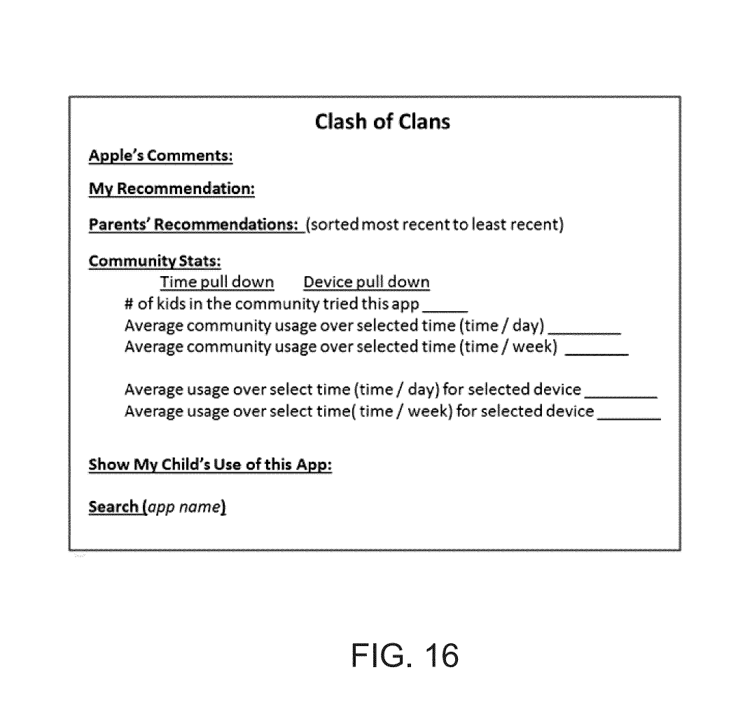

FIG. 16 is a screen shot template of what information is displayed when the parent the clicks on the “What is this?” button in FIG. 15. Other parents who are familiar with the game can provide insights and recommendations. Other information from the community includes the rating from the publisher, and usage statistics among other children in the same school.

Similar shared recommendations and insights from other parents can be associated with web sites, applications, and locations.

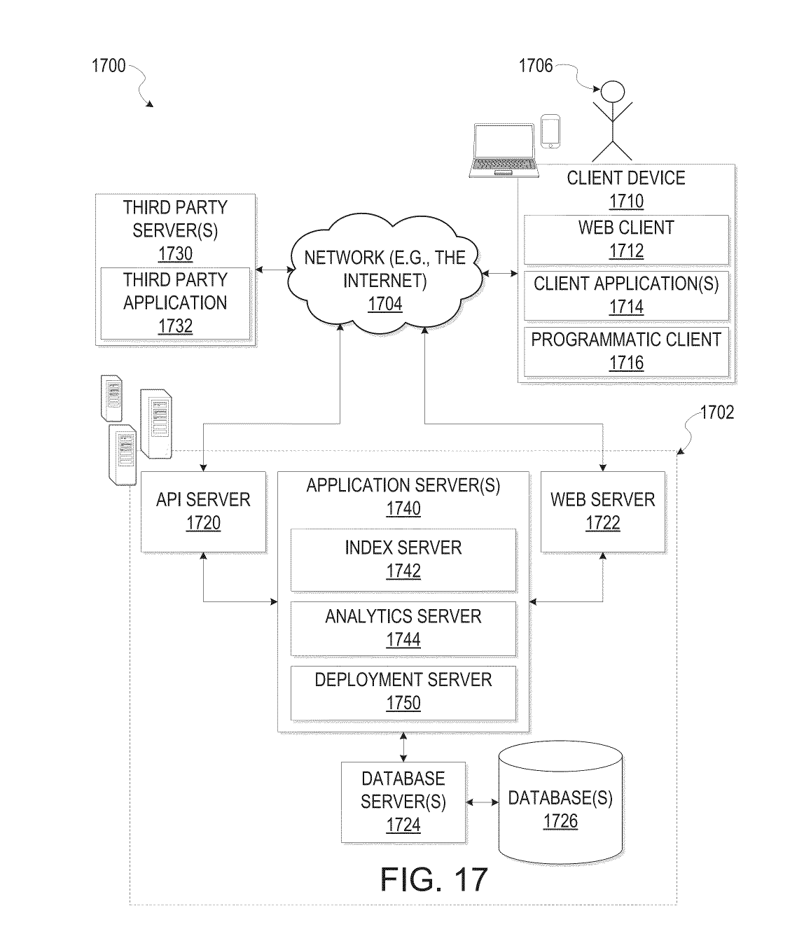

With reference to FIG. 17, an example embodiment of high-level client-server-based network architecture 1700 is shown. A networked system 1702 provides server-side functionality via a network 1704 (e.g., the Internet or wide area network (WAN)) to one or more client devices 1710. FIG. 1 illustrates, for example, a web client 1712 (e.g., a browser, such as the INTERNET EXPLORER® browser developed by Microsoft® Corporation of Redmond, Wash. State), an application 1714, and a programmatic client 1716 executing on client device 17170.

The client device 1710 may comprise, but are not limited to, a mobile phone, desktop computer, laptop, portable digital assistants (PDAs), smart phones, tablets, ultra books, netbooks, laptops, multi-processor systems, microprocessor-based or programmable consumer electronics, game consoles, set-top boxes, or any other communication device that a user may use to access the networked system 1702. In some embodiments, the client device 1710 may comprise a display module (not shown) to display information (e.g., in the form of user interfaces). In further embodiments, the client device 1710 may comprise one or more of a touch screens, accelerometers, gyroscopes, cameras, microphones, global positioning system (GPS) devices, and so forth. The client device 1710 may be a device of a user that is used to perform a transaction involving digital items within the networked system 1702. In one embodiment, the networked system 1702 is a network-based marketplace that responds to requests for product listings, publishes publications comprising item listings of products available on the network-based marketplace, and manages payments for these marketplace transactions. One or more users 1706 may be a person, a machine, or other means of interacting with client device 1710. A portion of the network 1704 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

A user provides input (e.g., touch screen input or alphanumeric input) to the client device 1710 and the input is communicated to the networked system 1702 via the network 1704. In this instance, the networked system 1702, in response to receiving the input from the user, communicates information to the client device 1710 via the network 1704 to be presented to the user. In this way, the user can interact with the networked system 1702 using the client device 1710.

An application program interface (API) server 1720 and a web server 1722 are coupled to, and provide programmatic and web interfaces respectively to, one or more application servers 1740. The application servers 1740 include the above-discussed index server 1742, analytics server 1744 and deployment server 1750, each of which may comprise one or more modules or applications and each of which may be embodied as hardware, software, firmware, or any combination thereof. The application servers 1740 are, in turn, shown to be coupled to one or more database servers 1724 that facilitate access to one or more information storage repositories or database(s) 1726.

Additionally, a third party application 1732, executing on third party server(s) 1730, is shown as having programmatic access to the networked system 1702 via the programmatic interface provided by the API server 1720. For example, the third party application 1732, utilizing information retrieved from the networked system 1702, supports one or more features or functions on a website hosted by the third party.

Further, while the client-server-based network architecture 1700 shown in FIG. 1 employs a client-server architecture, the present inventive subject matter is of course not limited to such an architecture, and could equally well find application in a distributed, or peer-to-peer, architecture system, for example. The various publication system 1742, payment system 1744, and personalization system 1750 could also be implemented as standalone software programs, which do not necessarily have networking capabilities.

The web client 1712 may access the applications servers 1740 via the web interface supported by the web server 1722. Similarly, the programmatic client 1716 accesses the various services and functions provided by the application servers 1740 via the programmatic interface provided by the API server 1720.

Modules, Components, and Logic

Certain embodiments are described herein as including logic or a number of components, modules, or mechanisms. Modules or components may constitute either software modules (e.g., code embodied on a machine-readable medium) or hardware modules. A “hardware module” or “hardware component” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module or component may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations

Accordingly, the phrases “hardware module” or “hardware component” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

In some embodiments, a hardware component may comprise part of a server with other hardware components, a single, dedicated server, or even a collection of servers.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

Machine and Software Architecture

The modules, methods, applications and so forth described herein may be implemented in some embodiments in the context of a machine and associated software architecture. The sections below describe representative software architecture(s) and machine (e.g., hardware) architecture that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things.” While yet another combination produces a server computer for use within a cloud computing architecture. Not all combinations of such software and hardware architectures are presented here as those of skill in the art can readily understand how to implement the invention in different contexts from the disclosure contained herein.

Software Architecture

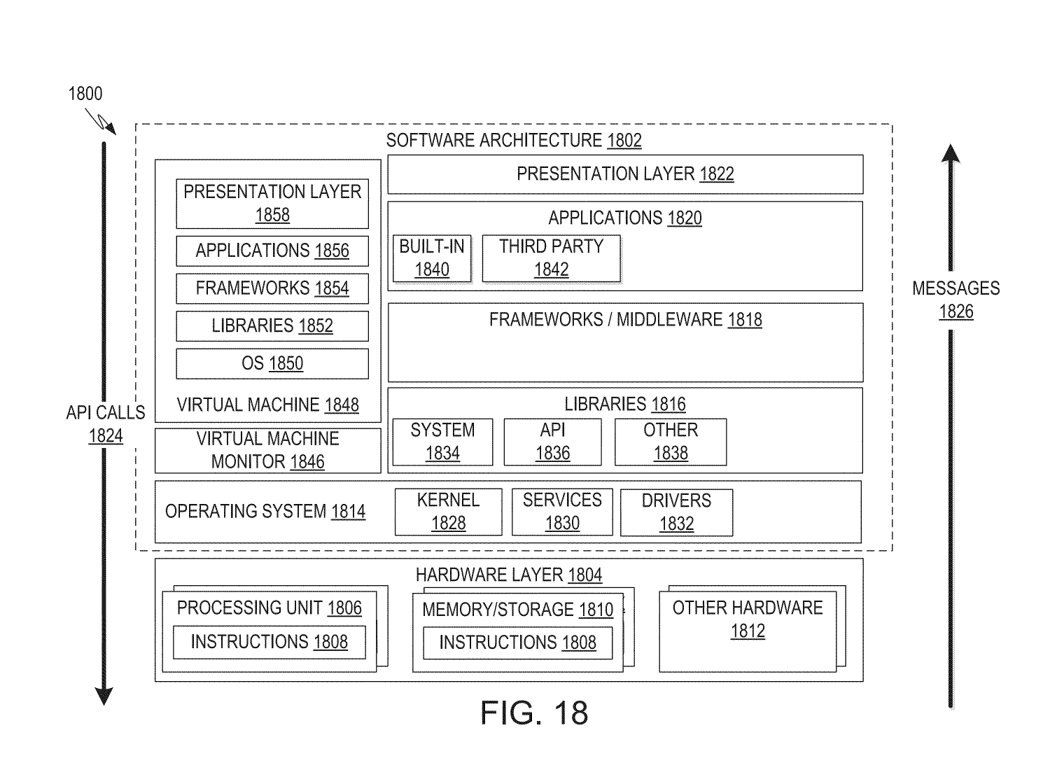

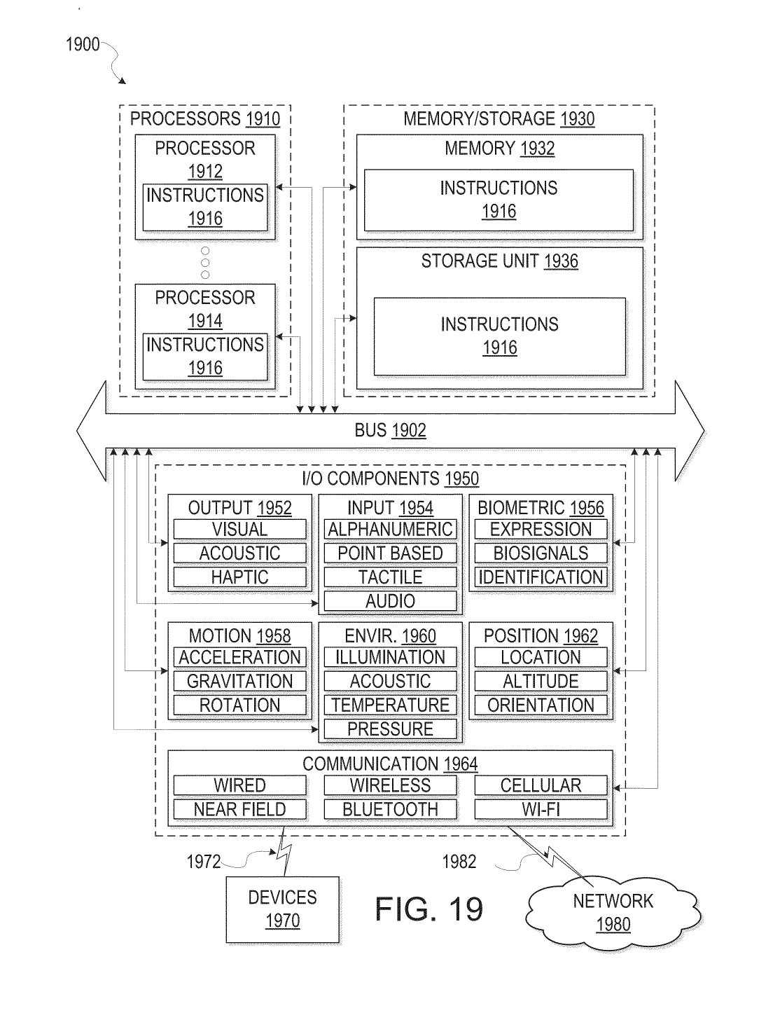

FIG. 18 is a block diagram 1800 illustrating a representative software architecture 1802, which may be used in conjunction with various hardware architectures herein described. FIG. 18 is merely a non-limiting example of a software architecture and it will be appreciated that many other architectures may be implemented to facilitate the functionality described herein. The software architecture 1802 may be executing on hardware such as machine 1900 of FIG. 19 that includes, among other things, processors 1910, memory 1930, and I/O components 1950. A representative hardware layer 1804 is illustrated and can represent, for example, the machine 1900 of FIG. 19. The representative hardware layer 1804 comprises one or more processing units 1806 having associated executable instructions 1808. Executable instructions 1808 represent the executable instructions of the software architecture 1802, including implementation of the methods, modules and so forth described herein. Hardware layer 1804 also includes memory and/or storage modules 1810, which also have executable instructions 1808. Hardware layer 1804 may also comprise other hardware as indicated by 1812 which represents any other hardware of the hardware layer 1804, such as the other hardware illustrated as part of machine 1900.

In the example architecture of FIG. 18, the software 1802 may be conceptualized as a stack of layers where each layer provides particular functionality. For example, the software 1802 may include layers such as an operating system 1814, libraries 1816, frameworks/middleware 1818, applications 1820 and presentation layer 1822. Operationally, the applications 1820 and/or other components within the layers may invoke application programming interface (API) calls 1824 through the software stack and receive a response, returned values, and so forth illustrated as messages 1826 in response to the API calls 1824. The layers illustrated are representative in nature and not all software architectures have all layers. For example, some mobile or special purpose operating systems may not provide a frameworks/middleware layer 1818, while others may provide such a layer. Other software architectures may include additional or different layers.

The operating system 1814 may manage hardware resources and provide common services. The operating system 1814 may include, for example, a kernel 1828, services 1830, and drivers 1832. The kernel 1828 may act as an abstraction layer between the hardware and the other software layers. For example, the kernel 1828 may be responsible for memory management, processor management (e.g., scheduling), component management, networking, security settings, and so on. The services 1830 may provide other common services for the other software layers. The drivers 1832 may be responsible for controlling or interfacing with the underlying hardware. For instance, the drivers 1832 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1816 may provide a common infrastructure that may be used by the applications 1820 and/or other components and/or layers. The libraries 1816 typically provide functionality that allows other software modules to perform tasks in an easier fashion than to interface directly with the underlying operating system 1814 functionality (e.g., kernel 1828, services 1830 and/or drivers 1832). The libraries 1816 may include system libraries 1834 (e.g., C standard library) that may provide functions such as memory allocation functions, string manipulation functions, mathematic functions, and the like. In addition, the libraries 1816 may include API libraries 1836 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 1816 may also include a wide variety of other libraries 1838 to provide many other APIs to the applications 1820 and other software components/modules.

The frameworks 1818 (also sometimes referred to as middleware) may provide a higher-level common infrastructure that may be used by the applications 1820 and/or other software components/modules. For example, the frameworks 1818 may provide various graphic user interface (GUI) functions, high-level resource management, high-level location services, and so forth. The frameworks 1818 may provide a broad spectrum of other APIs that may be used by the applications 1820 and/or other software components/modules, some of which may be specific to a particular operating system or platform.

The applications 1820 include built-in applications 1840 and/or third party applications 1842. Examples of representative built-in applications 1840 may include, but are not limited to, a contacts application, a browser application, a book reader application, a location application, a media application, a messaging application, and/or a game application. Third party applications 1842 may include any of the built in applications as well as a broad assortment of other applications. In a specific example, the third party application 1842 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 1842 may invoke the API calls 1824 provided by the mobile operating system such as operating system 1814 to facilitate functionality described herein.

The applications 1820 may use built in operating system functions (e.g., kernel 1828, services 1830 and/or drivers 1832), libraries (e.g., system 1834, APIs 1836, and other libraries 1838), frameworks/middleware 1818 to create user interfaces to interact with users of the system. Alternatively, or additionally, in some systems interactions with a user may occur through a presentation layer, such as presentation layer 1822. In these systems, the application/module “logic” can be separated from the aspects of the application/module that interact with a user.

Some software architectures use virtual machines. In the example of FIG. 18, this is illustrated by virtual machine 1848. A virtual machine creates a software environment where applications/modules can execute as if they were executing on a hardware machine (such as the machine of FIG. 19, for example). A virtual machine is hosted by a host operating system (operating system 1814 in FIG. 19) and typically, although not always, has a virtual machine monitor 1846, which manages the operation of the virtual machine as well as the interface with the host operating system (i.e., operating system 1814). A software architecture executes within the virtual machine such as an operating system 1850, libraries 1852, frameworks/middleware 1854, applications 1856 and/or presentation layer 1858. These layers of software architecture executing within the virtual machine 1848 can be the same as corresponding layers previously described or may be different.

Example Machine Architecture and Machine-Readable Medium

FIG. 19 is a block diagram illustrating components of a machine 1900, according to some example embodiments, able to read instructions from a machine-readable medium (e.g., a machine-readable storage medium) and perform any one or more of the methodologies discussed herein. Specifically, FIG. 19 shows a diagrammatic representation of the machine 1900 in the example form of a computer system, within which instructions 1916 (e.g., software, a program, an application, an applet, an app, or other executable code) for causing the machine 1900 to perform any one or more of the methodologies discussed herein may be executed. For example the instructions may cause the machine to execute the flow diagrams described above. The instructions transform the general, non-programmed machine into a particular machine programmed to carry out the described and illustrated functions in the manner described. In alternative embodiments, the machine 1900 operates as a standalone device or may be coupled (e.g., networked) to other machines. In a networked deployment, the machine 1900 may operate in the capacity of a server machine or a client machine in a server-client network environment, or as a peer machine in a peer-to-peer (or distributed) network environment. The machine 1900 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1916, sequentially or otherwise, that specify actions to be taken by machine 1900. Further, while only a single machine 1900 is illustrated, the term “machine” shall also be taken to include a collection of machines 1900 that individually or jointly execute the instructions 1916 to perform any one or more of the methodologies discussed herein.

The machine 1900 may include processors 1910, memory 1930, and I/O components 1950, which may be configured to communicate with each other such as via a bus 1902. In an example embodiment, the processors 1910 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 1912 and processor 1914 that may execute instructions 1916. The term “processor” is intended to include multi-core processor that may comprise two or more independent processors (sometimes referred to as “cores”) that may execute instructions contemporaneously. Although FIG. 19 shows multiple processors, the machine 1900 may include a single processor with a single core, a single processor with multiple cores (e.g., a multi-core process), multiple processors with a single core, multiple processors with multiples cores, or any combination thereof.

The memory/storage 1930 may include a memory 1932, such as a main memory, or other memory storage, and a storage unit 1936, both accessible to the processors 1910 such as via the bus 1902. The storage unit 1936 and memory 1932 store the instructions 1916 embodying any one or more of the methodologies or functions described herein. The instructions 1916 may also reside, completely or partially, within the memory 1932, within the storage unit 1936, within at least one of the processors 1910 (e.g., within the processor's cache memory), or any suitable combination thereof, during execution thereof by the machine 1900. Accordingly, the memory 1932, the storage unit 1936, and the memory of processors 1910 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 1916. The term “machine-readable medium” shall also be taken to include any medium, or combination of multiple media, that is capable of storing instructions (e.g., instructions 1916) for execution by a machine (e.g., machine 1900), such that the instructions, when executed by one or more processors of the machine 1900 (e.g., processors 1910), cause the machine 1900 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1950 may include a wide variety of components to receive input, provide output, produce output, transmit information, exchange information, capture measurements, and so on. The specific I/O components 1950 that are included in a particular machine will depend on the type of machine. For example, portable machines such as mobile phones will likely include a touch input device or other such input mechanisms, while a headless server machine will likely not include such a touch input device. It will be appreciated that the I/O components 1950 may include many other components that are not shown in FIG. 19. The I/O components 1950 are grouped according to functionality merely for simplifying the following discussion and the grouping is in no way limiting. In various example embodiments, the I/O components 1950 may include output components 1952 and input components 1954. The output components 1952 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1954 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 1950 may include biometric components 1956, motion components 1958, environmental components 1960, or position components 1962 among a wide array of other components. For example, the biometric components 1956 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1958 may include acceleration sensor components (e.g., accelerometer), gravitation sensor components, rotation sensor components (e.g., gyroscope), and so forth. The environmental components 1960 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1962 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1950 may include communication components 1964 operable to couple the machine 1900 to a network 1980 or devices 1970 via coupling 1982 and coupling 1972 respectively. For example, the communication components 1964 may include a network interface component or other suitable device to interface with the network 1980. In further examples, communication components 1964 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1970 may be another machine or any of a wide variety of peripheral devices (e.g., a peripheral device coupled via a Universal Serial Bus (USB)).

Moreover, the communication components 1964 may detect identifiers or include components operable to detect identifiers. For example, the communication components 1964 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1964, such as, location via Internet Protocol (IP) geo-location, location via Wi-Fi® signal triangulation, location via detecting a NFC beacon signal that may indicate a particular location, and so forth.

Transmission Medium

In various example embodiments, one or more portions of the network 1980 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1980 or a portion of the network 1980 may include a wireless or cellular network and the coupling 1982 may be a Code Division Multiple Access (CDMA) connection, a Global System for Mobile communications (GSM) connection, or other type of cellular or wireless coupling. In this example, the coupling 1982 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 1916 may be transmitted or received over the network 1980 using a transmission medium via a network interface device (e.g., a network interface component included in the communication components 1964) and utilizing any one of a number of well-known transfer protocols (e.g., hypertext transfer protocol (HTTP)). Similarly, the instructions 1916 may be transmitted or received using a transmission medium via the coupling 1972 (e.g., a peer-to-peer coupling) to devices 1970. The term “transmission medium” shall be taken to include any intangible medium that is capable of storing, encoding, or carrying instructions 1916 for execution by the machine 1900, and includes digital or analog communications signals or other intangible medium to facilitate communication of such software.

Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method to monitor activities on a plurality of devices associated with a common user, the method comprising:
receiving, at an index component and from respective monitors installed on each of the plurality of devices, activity data associated with the common user, the activity data including an identifier associated with the common user;
aggregating and analyzing, at an analytics component, the activity data using the identifier associated with the common user to generate analytics data relating to the activities on the plurality of devices associated with the common user; and
presenting, using the analytics component, the analytics data.

2. The method of claim 1, wherein the identifier is a device identifier, and wherein the aggregating of the activity data includes determining that the device identifier is associated with the common user.

3. The method of claim 1, wherein the identifier is a user identifier, and wherein the aggregating of the activity data includes aggregating activity data that includes the user identifier.

4. The method of claim 1, including validating integrity of at least a first monitor installed on a first device of the plurality of devices.

5. The method of claim 4, wherein the validating of the integrity of the first monitor comprises detecting a discrepancy between an output of the first monitor and an output of a second monitor, both the first and second monitors being installed on a common machine but monitoring different activities of the common machine.

6. The method of claim 1, including receiving, at the index component, first activity data from a first monitor and second activity data from a second monitor, the first and second monitors being installed on a common device of the plurality of devices.

7. The method of claim 6, wherein the first activity data pertains to a first type of activity and the second activity data pertains to a second type of activity.

8. The method of claim 6, wherein the first activity data pertains to activity of a first application installed on the common device, and the second activity data pertains to activity of a second application installed on the common device.

9. The method of claim 1, wherein the activity data includes at least one of location data, network traffic data, browser URL data and media data associated with an activity performed using a first application installed on a first device of the plurality of devices.

10. The method of claim 1, wherein the aggregating of the activity data includes determining that a first monitor on a first device of the plurality of devices experienced a termination event.

11. The method of claim 10, wherein the determining of that the first monitor experienced a termination event includes determining that the first monitor failed to generate first activity data correlated to second activity data generated by a second monitor on the first device.

12. A system to monitor activities on a plurality of devices associated with a common user, the system comprising:
an index component coupled to receive activity data from respective monitors installed on each of the plurality of devices, the activity data being associated with the common user and including an identifier associated with the common user;
an analytics component to:
aggregate the activity data using the identifier associated with the common user to generate analytics data relating to the activities on the plurality of devices associated with the common user; and
present the analytics data.

13. The system of claim 12, wherein the identifier is a device identifier, the analytics component being configured to determine that the device identifier is associated with the common user.

14. The system of claim 12, wherein the identifier is a user identifier, the analytics component being configured to aggregate activity data that includes the user identifier.

15. The system of claim 12, wherein the analytics component is configured to validate at least a first monitor installed on a first device of the plurality of devices.

16. The system of claim 15, wherein the analytics component is configured to detect a discrepancy between an output of the first monitor and an output of a second monitor, both the first and second monitors being installed on a common machine but monitoring different activities of the common machine.

17. The system of claim 12, wherein the index component is configured to receive first activity data from a first monitor and second activity data from a second monitor, the first and second monitors being installed on a common device of the plurality of devices.

18. The system of claim 17, wherein the first activity data pertains to activity of a first application installed on the common device, and the second activity data pertains to activity of a second application installed on the common device.
